(19) United States
(12) Patent Application Publication
(10) Pub. No.: US 2026/0185625 A1
(43) Pub. Date: Jul. 2, 2026

(54) One-Way Drain Valve with Atmospheric Adjustable Pressure Post, Anti-Descent Retention Clips, and Removable Debris Screen

(71) Applicant: Giovanni Raoul Fima, Scottsdale, AZ (US)

(72) Inventor: Giovanni Raoul Fima, Scottsdale, AZ (US)

(21) Appl. No.: 19/437,591

(22) Filed: Dec. 31, 2025

Related U.S. Application Data
(60) Provisional application No. 63/833,691, filed on Jan. 2, 2025.

(51) Int. Cl. F16K 24/04; B01D 29/31

(52) U.S. Cl. CPC F16K 24/04; B01D 29/31; B01D 2201/4015; B01D 2201/4092; F16K 2200/402

(57) ABSTRACT

A gravity drain valve assembly includes a valve housing, a silicone gasket having a plurality of lower sealing veins and a larger upper sealing vein, a flexible flapper membrane, and an adjustable post with a compression O-ring enabling micro-adjustment of sealing force. Stainless-steel anti-descent clips positioned at an upper region of the valve housing prevent downward migration caused by a removable debris basket attached at the lower end of the valve. Additional embodiments include customizable drain screens with integrated threaded medallions, integrated cast screen/valve housings, and dual-membrane assemblies. The system improves sealing reliability, debris management, structural retention, and long-term serviceability in wastewater drains.

### CROSS-REFERENCE TO RELATED APPLICATION(S)

This application claims priority to and the benefit of U.S. Provisional Patent Application Ser. No. 63/833,691, filed Jan. 2, 2025, the entire disclosure of which is hereby incorporated by reference.

### TECHNICAL FIELD

This disclosure relates to gravity drain valves, and more particularly to high-flow, one-way drain valves incorporating adjustable flapper membranes, removable debris-capture elements, structural anti-descent retention mechanisms, customizable drain screens, and improved sealing gaskets.

### BACKGROUND

Drain valves used in commercial, industrial, and public facilities must allow liquids to drain freely while preventing return flow of gases, odors, airborne contaminants, pests, and wastewater. Conventional valves suffer from gasket compression, lack of debris capture, inadequate structural retention, inconsistent sealing due to silicone variability, and lack of customizable drain screens.

### SUMMARY

Disclosed herein are implementations of a drain valve featuring one or more of an enlarged upper gasket vein, anti-descent clips, removable debris baskets, a micro-adjustable O-ring-braked sealing post, customizable medallion drain screens, integrated cast screen/housings, and multiple flapper configurations.

In one implementation, a drain valve assembly has a valve housing having an upper region and a lower region and defining a flow passage and a gasket disposed around the valve housing. The gasket comprises a plurality of lower circumferential sealing veins and an upper sealing vein having a diameter greater than each of the lower sealing veins. The assembly further has a flexible flapper membrane disposed within the flow passage, a central post supporting the flexible flapper membrane, a debris basket attachment interface located at the lower region of the valve housing, a removable debris basket detachably secured to the debris basket attachment interface, and a plurality of stainless-steel anti-descent clips disposed at the upper region of the valve housing and extending outwardly toward the gasket. The anti-descent clips are configured to resist downward movement of the valve housing caused by weight of the debris basket during use.

In another implementation, a drain valve has a valve housing having an internal sealing surface, a flexible flapper membrane configured to contact the internal sealing surface, and a telescopic post assembly comprising: a male threaded portion, a female threaded sleeve, and a compression O-ring disposed on the male threaded portion and engageable with the female threaded sleeve to provide frictional braking. Rotation of the male threaded portion adjusts a position of the flapper membrane relative to the internal sealing surface, and the compression O-ring maintains the adjusted position by resisting rotational back-movement.

In another implementation, a drain screen and valve combination has a perforated drain screen having a central aperture, a removable medallion received within the central aperture, the medallion comprising an upper surface which may include a logo or identifier, and a threaded sleeve extending from an underside of the medallion, a flapper valve post threadably engageable with the threaded sleeve and extending downward beneath the drain screen, and a flapper valve membrane supported by the flapper valve post. The medallion may simultaneously provide decorative branding and structural support for the flapper valve post.

In another implementation, an integrated drain valve assembly has a metal drain screen and a valve housing cast as a single integrated body, a threaded sleeve disposed beneath a central portion of the drain screen, a threaded post received within the threaded sleeve, and a flexible flapper membrane supported by the threaded post. The integrated body provides structural rigidity and eliminates the need for a separate outer gasket.

In another implementation, a method of installing a drain valve assembly comprises: inserting a valve housing carrying a gasket into a drain pipe; engaging stainless-steel anti-descent clips at an upper region of the valve housing so that the clips bear against the gasket and prevent downward travel of the valve housing; attaching a debris basket to a debris basket attachment interface located at a lower region of the valve housing; and adjusting a flapper valve post by rotating a threaded portion against a compression O-ring to establish sealing pressure between a flapper membrane and an internal sealing surface.

In another implementation, a valve housing assembly has a plastic valve housing having a plurality of outward ribs, a silicone gasket mounted over the outward ribs, the gasket comprising a plurality of lower sealing veins and an upper sealing vein larger than the lower sealing veins, and a debris basket configured for attachment to a lower region of the valve housing.

In another implementation, a drain valve has a valve housing, a telescopic post comprising a threaded adjustment mechanism and a compression O-ring, a first flapper membrane mounted to the post, and a second flapper membrane mounted to the post below the first flapper membrane, wherein both flapper membranes are adjustable in height through the telescopic post.

Iin another implementation, a drain valve comprises a housing, a flapper membrane, and a telescopic post with a compression O-ring providing frictional braking.

In another implementation, a valve housing has a cylindrical body, a plurality of slits formed through an upper region of the cylindrical body, and a plurality of stainless-steel clips each having a bent end received within a corresponding slit, wherein the clips are configured to anchor the valve housing against downward movement within a drain pipe.

In another implementation, as drain screen and valve combination comprises a drain screen, a valve housing, wherein the drain screen and the valve housing are a single cast piece of metal, a single-use vent in the drain screen, the single-use vent assessable after installation, and a flapper valve in the valve housing and supported by a flapper post extending into the valve housing from a center of the drain screen. The combination may further comprise a medallion in the center of the drain screen and visible after installation, the medallion providing decorative branding.

In another implementation, a drain screen and valve combination comprises a drain screen, a plastic valve housing attached to the drain screen, a single-use vent in the drain screen, the single-use vent assessable after installation, and a flapper valve in the valve housing and supported by a flapper post extending into the valve housing from a center of the drain screen.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a top view of a plastic valve with raised struts and metal clips intended to keep the valve from sliding down the drain.

FIG. 2 is a cross-sectional view of a metal clip mounted on the top of the valve.

FIG. 3 is a cross-sectional view of the plastic valve with a larger top vein and metal clips and female bayonets at the bottom of the valve.

FIG. 4 is a partial cross-section of the valve showing a hollow post for atmospheric control and shut off screw at the bottom.

FIG. 5 is an example of a debris basket.

FIG. 6 is a partial valve cross-section with raised arches and a female plastic threaded sleeve for mounting a threaded hollow post.

FIG. 7 is a one-piece combination screen/valve with a top center medallion and a male threaded mini post under for attaching a post with a silicon membrane attached to it.

FIG. 8 is another version of a one-piece metal cast screen/valve with a changeable medallion at the center of the screen. The medallion can be cast as one-piece and male threaded at one side, used for attaching a central post.

FIG. 9 is a bottom view of a flapper valve.

FIG. 10 is a cross-sectional view of a screen and valve combination.

FIG. 11 is a partial cross-section with supporting struts flush even with the valve entrance and a threaded female sleeve injection molded as one-piece. The post is hollow to allow atmospheric pressure to escape. The bottom of the post can be threaded for anchoring a debris screen.

FIG. 12 is a bottom view of a metal perforated screen with a plastic housing attached.

### DETAILED DESCRIPTION

Drain valves used in commercial, industrial, and public facilities must allow liquids to drain freely while preventing return flow of gases, odors, airborne contaminants, pests, and wastewater. Conventional valves suffer from gasket compression, lack of debris capture, inadequate structural retention (such as veins compressing and remaining compressed, preventing re-use), inconsistent sealing due to silicone variability, and lack of customizable drain screens.

The drain valves and drain valve assemblies disclosed herein provide a high-flow, one-way drain valve having a silicone outer gasket with a top vein larger than the three lower veins to ensure long-term sealing integrity. The valve housing supports stainless-steel push clips which prevent the valve from sliding downward under load from a removable debris screen.

A central post may be solid or hollow and may include adjustable threaded engagement with an O-ring to provide compression friction that maintains precise flapper membrane contact pressure. A silicone flapper membrane attaches to the post by means of a shoulder and is configured to collapse under fluid weight aided by underside recess grooves. A threaded post extension may be used to secure a debris basket beneath the flapper membrane.

The lower end of the housing may include female bayonet slots allowing attachment of various debris screens such as wire baskets, stamped screens, or frame-supported baskets. The debris screen attaches at the bottom of the valve. The debris screen may have a wire frame and a plurality of support wires, the debris basket configured to facilitate manual insertion and removal from beneath the drain valve. To address the added weight of the drain valve due to the debris basket, spring clips attach to the inside and outside on top of the valve area to prevent the drain valve from sliding into the drain.

A removable atmospheric pressure cap or screw enables selective venting. Raised or flat struts support the hollow post and provide airflow pathways.

Alternative embodiments include a one-piece metal screen/valve structure and screens with removable medallions that allow branding or logo customization while simultaneously anchoring the flapper post.

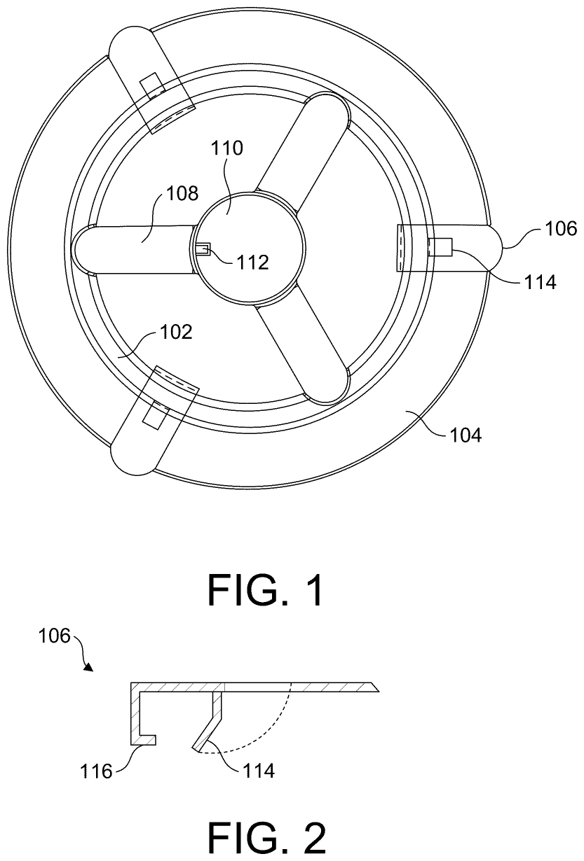

Referring to FIG. 1, a valve housing 102 has an outer gasket 104 in place, with retaining clips 106, which may be stainless steel and may be press fit. The gasket 104 is used to anchor the drain valve inside a drain housing while providing a water tight seal between the drain valve and the drain housing. One or more raised struts 108 increase flow and easy insertion and extraction from inside the drain housing. However, if a tight space doesn't permit a drain valve with raised struts 108, then a drain valve with lower ribs can be used in its place. A rubber or plastic adjustable cap 110 is used to adjust the vent pressure. An adjustable open/closed atmospheric pressure port indicator marking 112 is also shown. The retaining clip 106 is used to prevent the drain valve from sliding down the drain pipe after service. Two or more can be used depending on the valve size. The retaining clip 106 has a knock out portion 114 folded downward on the metal clip to secure the retaining clip to the plastic valve housing 102 and inside valve walls and between the outside of the plastic valve housing 102 and the silicon gasket 104.

FIG. 2 is a side view of the retaining clip 106 (not to scale) with the knock out portion 114 folded down, used to secure the clip to the valve housing 102. The retaining clips 106 are used to prevent the drain valve from slipping down the drain when a debris screen is attached at the bottom of the drain valve. The knock out portion 114 is formed to match the geometry between the valve housing 102 and inside diameter of the silicon gasket 104. The front 116 of the retaining clip 106 is bent 90 degrees to secure the retaining clip 106 to the inside of the plastic valve housing 102 in a respective slot.

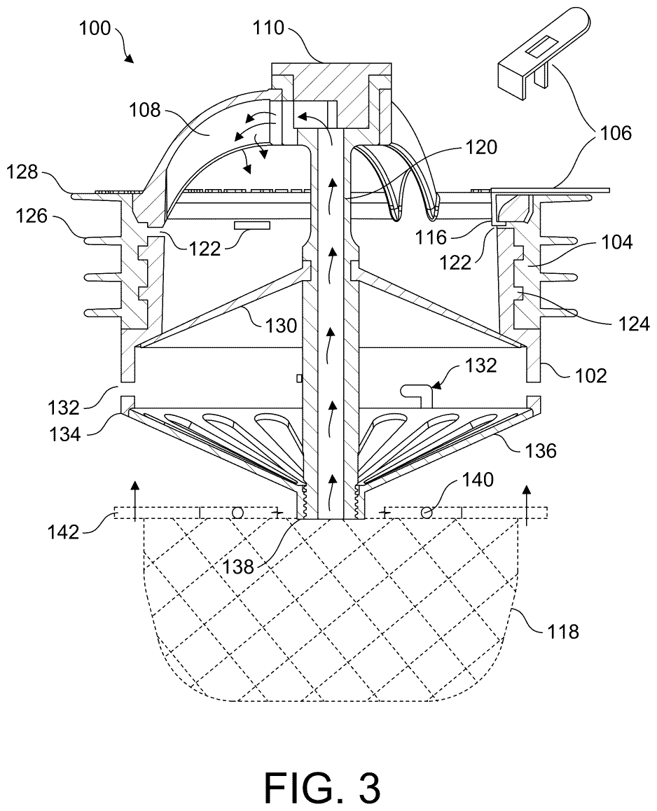

FIG. 3 is a cross-section of a drain valve 100 or drain valve assembly with retaining clips 106 and a debris catcher 118, in metal, wire screen or plastic screen where building codes permit. The rubber adjustable cap 110 used for on/off atmospheric control under the raised arch struts. The raised strut 108 is used to vent out atmospheric pressure in the sewer line. A hollow post 120 expedites atmospheric flow in the drain system. The hollow post 120 can be extended and threaded at the bottom for the purpose of anchoring the debris catcher 118. Retaining clips 106 easily snap on through the top of the valve housing 102, the front 116 of the retaining clip 106 fitting in a small female slit 122 in the valve housing 102 to prevent the drain valve 100 from slipping down into the drain from the added weight of the debris catcher 118. The silicon gasket 104 is pressed to the outer side of the valve housing 102. The valve housing 102 has small male ribs 124 around the outside of the valve housing 102 used to anchor the silicon gasket 104 to the valve housing 102, preventing the silicon gasket from moving. Lower veins 126 on the outer side of the gasket 104 flex or compress tightly when inserted inside a drain providing a water and gas seal between the drain valve 100 and inside the drain walls. The top vein 128 is larger than the lower veins 126, such as by a minimum 3 mm to 5 mm or more, if necessary, to provide an additional seal when inserted inside a floor drain housing.

A silicon flapper 130 is used to prevent airborne sewer gases and odors from exiting the drain and entering the atmosphere, while preventing back flow pressure. The hollow post 120 can be of a length to allow securing the silicon flapper 130 and various sizes of a debris catcher 118 at the bottom of the drain valve 100. Female bayonet slots 132 (typically 3 or more) are at the bottom of the valve to accommodate various sizes screens. Bayonet slots 132 at the bottom of the plastic valve housing 102 accommodate a debris catcher 118 with matching male posts. A 90 degree recess 134 at the bottom of the valve is used for securing a small metal screen to the perimeter base of the valve housing 102. A plastic or metal stamped screen 136 is attached at the base of the hollow post 120 with threads 138 to catch larger debris. A metal frame 140 with male bayonets 142 anchor the debris catcher 118 at the bottom of the hollow post 120.

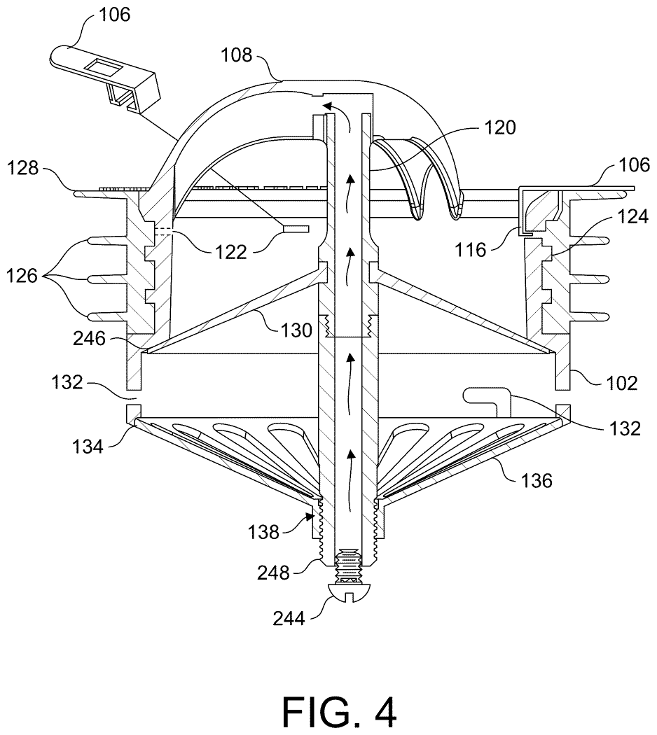

FIG. 4 is a drain valve 200 similar to FIG. 3. Like numbers are used for like parts. In this implementation, a plastic or metal screw 244 is used to block atmospheric pressure emanating from the drain. A 58 degree plastic valve slope seal perimeter 246 is shown. As in FIG. 3, to accommodate various shapes, sizes and types of debris catchers, the valve housing 102 is extended at the bottom to provide for bayonet slots 132 for debris catchers 118 with matching male bayonets 142. Alternatively, the debris catcher 118 can be anchored to the bottom of the hollow post 120 with threads 248.

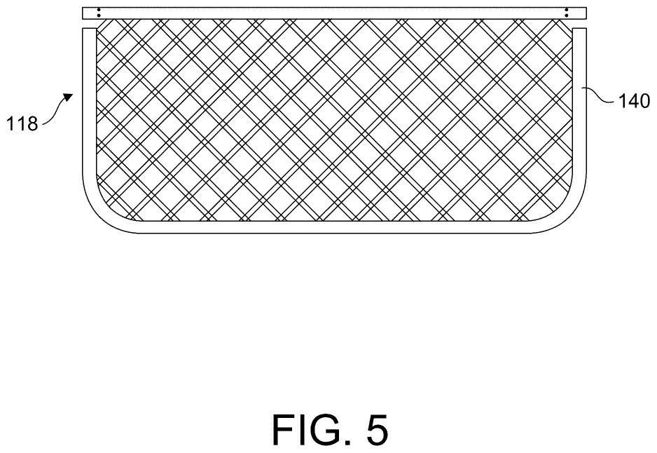

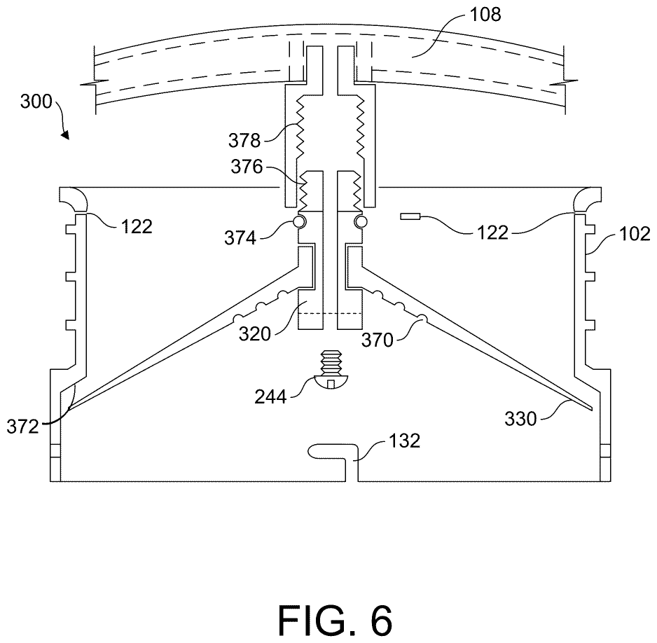

FIG. 5 is a debris catcher 118. The debris catcher can be a metal wire basket that attaches to the bottom of a drain valve, and can be fabricated in any size to fit a new or any existing floor drain. The debris catcher 118 may have a metal frame 140 that may extend along the bottom of the catcher to provide support. The wire basket may be welded to the metal frame 140 FIG. 6 is a cross-section of another implementation of a drain valve 300. Elements in common with FIGS. 3 and 4 will remain the same. The drain valve 300 has hollow post 320 that can be plastic or metal and is threaded at the top. A plastic or metal screw 244 is used to close atmosphere pressure venting at the bottom. A flexible silicon flapper 330 is attached with one or more recess channels 370 under the silicon flapper 330 to help collapse the silicon flapper 330 under fluid mass. The downward angle of the silicon flapper 330 is set at 58 degrees to provide a great seal from airborne pathogens, mosquitoes, cockroaches, and fluid drain back flow from exiting the valve. The silicon flapper shoulder 372 is used to keep the flexible membrane perfectly anchored to the circular seal area of the perimeter valve inside wall. An O-ring 374 is attached to the hollow post 320, providing breaking friction and pressure when adjusting the silicon flapper 330 membrane up or down to make contact with the shoulder 372. The hollow post 320 has a threaded top 376. A female anchored threaded sleeve 378 receives the threaded top 376 with the ‘O’ ring, while providing pressure and hermetic seal between sleeve and post. The sleeve 378 can be cast as one piece in plastic or metal with the valve's struts 108.

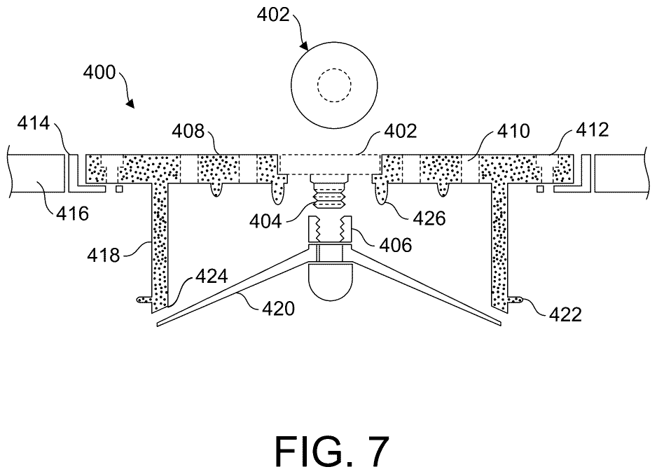

FIG. 7 is a cross-section of a drain screen and valve combination 400 all in one. No gasket is required around the valve housing. A removable medallion-sized metal brass insert 402 (shown in plan view and in the drain screen and valve combination 400) has a threaded post 404 underneath. The insert 402 can be used to display the client's name or logo. The insert 402 is centrally located. The extruded threaded post 404 is used for attaching the silicon flapper post 406. A top perforated screen 408 can be fabricated in plastic, brass or stainless steel, depending on need or client preference. The screen 408 has holes 410 to expedite fluid flow. The screen 408 is mounted via screw mounts 412 on the screen's perimeter. Two (2) or more are required depending on the drain's screen size. The valve housing 414 has a perimeter that is flush with the finished floor 416 and is used to anchor the drain screen and valve combination 400 to a new or existing drain. The valve wall 418, under the screen 408, forms the valve cavity in which the silicon flapper 420 is located. The screen 408 and the valve wall 418 can be fabricated as a single piece of metal. Alternatively, the valve wall 418 can be prefabricated in ABS plastic and attached under the screen.

Protruding bayonets 422 are for attaching the debris catcher to the bottom of the valve wall 418, with three (3) or more are needed depending on debris catcher size(s). The distal end 424 of the valve wall 418 is angled 58 degrees to provide a secure seal between the valve wall 418 and silicon flapper 420. However, depending on the flapper diameter and durometer, the angle may vary plus or minus 5 degrees. Solid cast structural ribs 426 of various sizes are directly under the screen 408 to support weight, such as, for example, the weight of a rolling forklift tire on top of the screen 408. The underside of the silicon flapper 420 has a durometer of between 25 to 38 depending on the drain size.

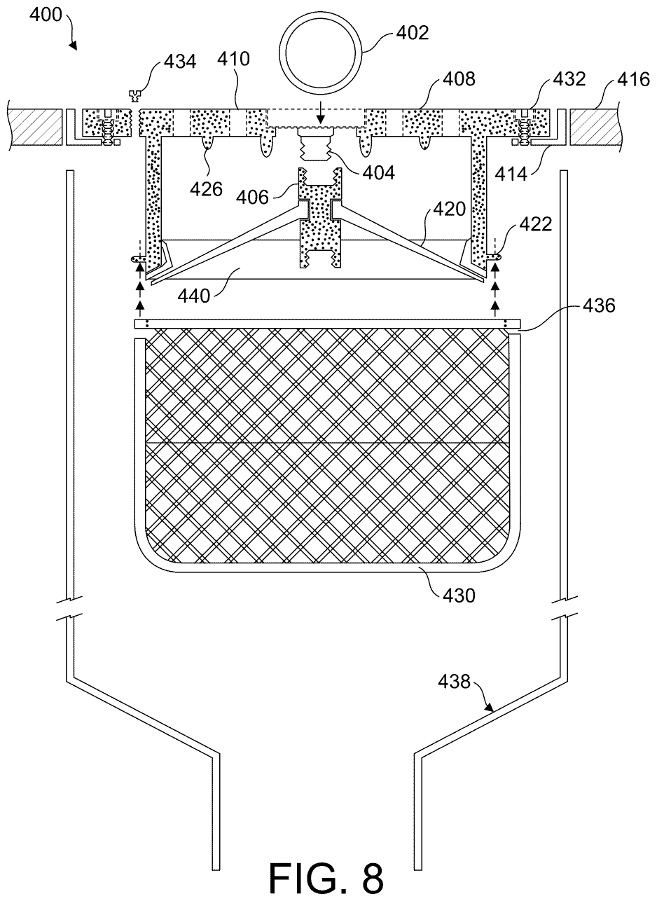

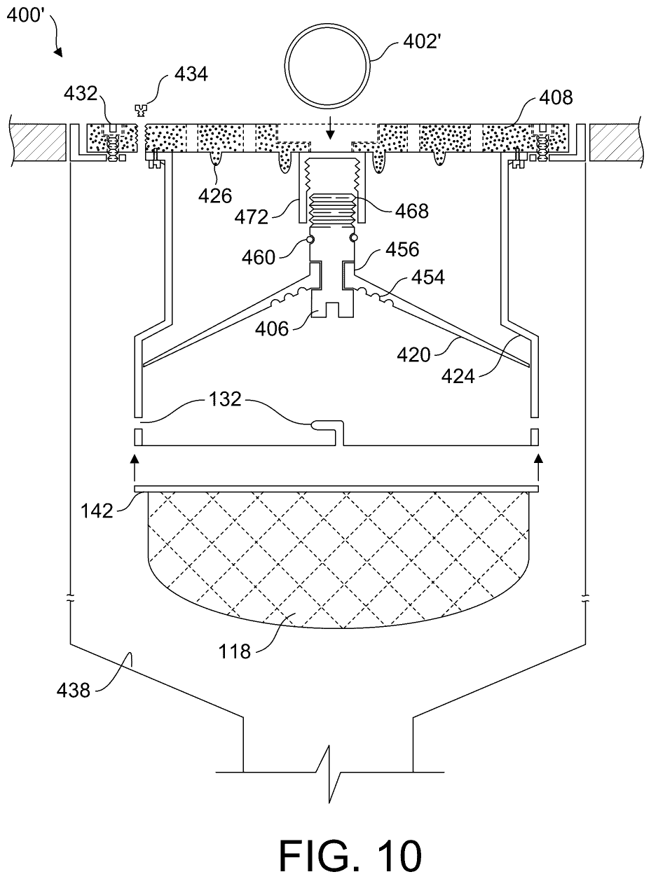

FIG. 8 illustrates the drain screen and valve combination 400 of FIG. 7 with a debris catcher 430. Metal screws 432 are used to anchor the drain screen and valve combination 400 to a new drain or existing drain housing using screw mounts 412. The insert 402 with the threaded post 404 on its underside can be spot welded or soldered to the top on the screen 408. The insert 402 may have a beveled side wall with the screen having a reciprocating beveled wall to receive the insert 402. A small threaded opening with a metal screw is a single-use vent 434. When the screw is in place, no venting takes place. When the screw is removed, atmospheric pressure will escape from the drain housing. The bottom of the flapper post 406 can be threaded, and may be male threads or female threads, used to attach a center post extension for attaching a debris catcher of a different size or a screen such as screen 136. Alternatively, protruding bayonets 422 can be used for attaching the debris catcher 430. Debris catcher recess openings 436 are used for attaching the debris catcher 430 to the bayonets 422. The bottom of the flapper post 406 can alternatively have a screw driver slot as shown in FIG. 10 at the bottom of the flapper post 406, used for removal or controlling the silicon flapper 420 perimeter pressure against the valve seal area. The flexible silicon flapper 420 can be injection or compression molded. Because no two silicon flapper durometer ‘flex’ the same, a contact pressure adjustable post can be used. Also in FIG. 10, the insert 402 may have female threads rather than male threads, with the flapper post 406 having the opposite. The drain 438 has a housing of metal or plastic. A plastic sleeve 440 can be pressure fitted at the bottom of the metal perimeter valve wall, used only on existing metal drain screens, to create a smooth 58 degree perimeter seal area for the silicon flapper 420.

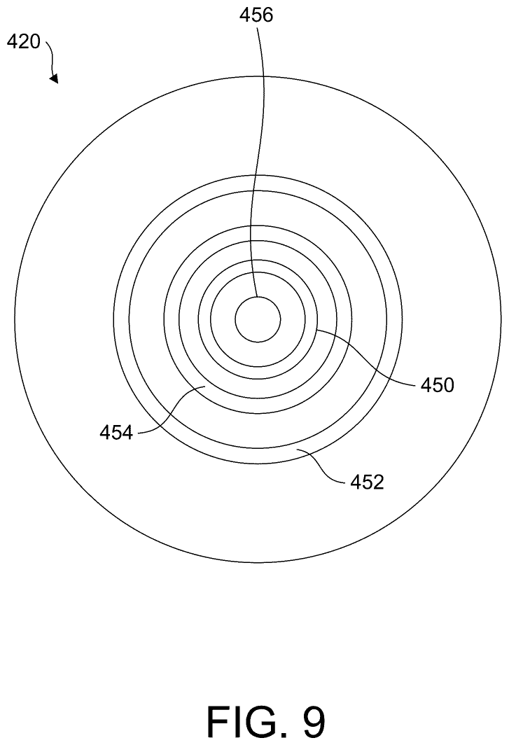

FIG. 9 is a bottom view of a silicon flapper 420. Recess ring channels 450, 452, 454 may be formed around the full circumference at various positions, allowing the silicon flapper 420 to easily collapse under fluid pressure. A shoulder core 456 anchors the silicon flapper 420 to the flapper post 406.

As shown in FIG. 10, the drain screen and valve combination 400 may also utilize an O-ring 460 as previously described with respect to FIG. 6, on the flapper post 406 to provide breaking movement on the post under fluid flow. Other elements of FIG. 10 are described with respect to FIG. 8.

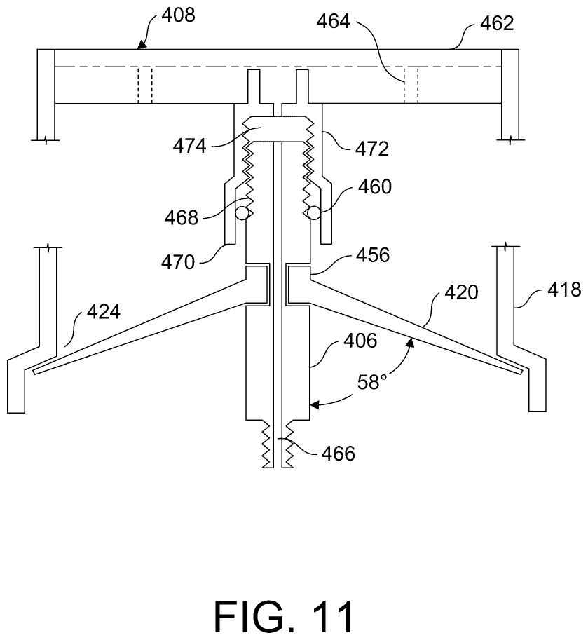

FIG. 11 shows a partial view of the drain screen and valve combination 400, focusing on the adjustable flapper post 406. The drain screen 408 may have one or more surface struts 462 with one or more solid micro-walls 464 under the surface struts 462 to keep the plastic strut from dimpling during the injection molding process. This flapper post 406 has an elongated threaded bottom used to anchor a debris metal screen at the bottom of the valve. A hollow atmospheric opening 466 is inside the flapper post 406, used with a plastic valve housing. The threaded top 468 of the flapper post 406 is used for raising the post up or down during installation. The O-ring 460 is just below the threads and provides breaking friction when adjusting the silicon flapper 420 against the valve body. The female threaded sleeve bottom 470 is made slightly larger to allow the O-ring to compress while adjusting the silicon flapper 420 up or down. A female upper sleeve 472 is attached to the underside of the struts via adhesive if plastic or welded or cast is metal. A minimum (0.250″) or (6.36 mm) compression space 474 is provided for the adjustment of the flapper post 406. By adjusting the post up or down as necessary, it provides a positive hermetic seal from fluids inside the drain system, airborne pathogen, sewer gases, mosquitos, cockroaches and in some cases rodents when fitted with a catch debris screen.

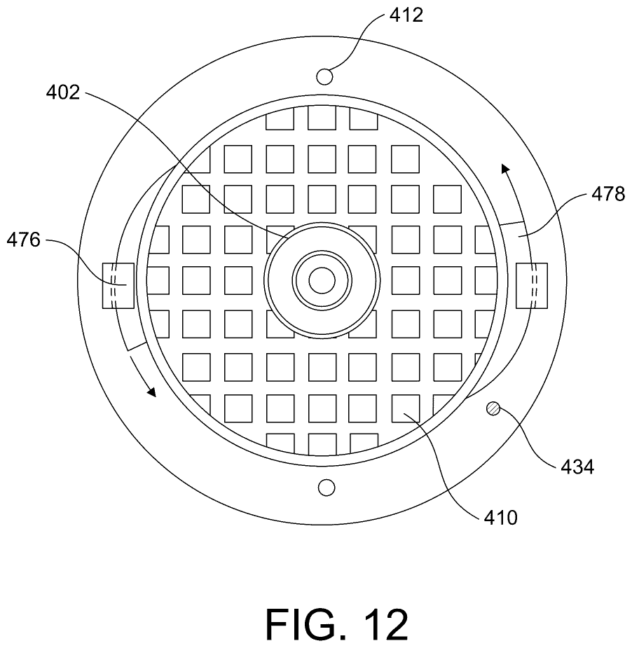

FIG. 12 shows the underside of the metal drain or plastic screen 408, used on top of a floor drain. Two screw mounts 412 are used to secure the screen to the floor drain housing. A screen single-use vent 434 is for a single lifetime use, either opened or closed. A metal cast L-shape clip 476 is used for anchoring the plastic valve hollow body to the underside of the screen. Other methods for attaching the hollow plastic valve under the screen can be used. Protruding ears 478 may be used, the number depending on valve diameter and size, on top of the hollow wall housing used for anchoring the hollow valve wall to the underside of the metal screen. The underside of the insert 402 is welded or soldered on the top center of the metal screen and may have the client logo or name. The screen perforation holes 410 expedite flow into the floor drain.

As described above, examples of drain valve assemblies and drain screen and valve combinations may include the following in the combination described or any other combination as supported herein. A drain valve assembly comprises a valve housing defining a flow passage, a gasket on an exterior wall of the valve housing and comprising lower circumferential sealing veins and an upper circumferential sealing vein that has a diameter greater than a diameter of each of the lower circumferential sealing veins, a flapper post positioned centrally within the valve housing, a flapper valve attached to the flapper post, a debris basket attachment interface, a removable debris basket, and anti-descent clips disposed at an upper region of the valve housing and configured to resist downward movement of the valve housing. The upper sealing vein may be at least 3 mm larger than the lower sealing veins. The debris basket interface may be a bayonet coupling or may comprise a threaded bottom of the flapper post, as examples.

The anti-descent clips are insertable before or after installation of a drain valve.

The flapper valve includes one or more underside recess channels configured to assist collapse under pressure. The flapper valve is molded at an angle of between 53° and 63°, the angle measured from an underside of the flapper valve to the flapper post. The flapper post has a threaded upper end with an O-ring on the flapper post above the flapper valve and below the threaded upper end, the flapper post adjustable by rotating the threaded upper end in a threaded sleeve, the O-ring compressing between the flapper post and the threaded sleeve.

As described above, a drain valve assembly comprises a valve housing having a plurality of outward ribs, a gasket mounted over the outward ribs, and a debris basket configured for attachment to a lower region of the valve housing. The gasket comprises a plurality of lower circumferential sealing veins extending away from the valve housing and an upper circumferential sealing vein having a diameter greater than a diameter of each of the lower circumferential sealing veins. The debris basket may have bayonets extending from a frame which are received in bayonet slots in the lower region of the valve housing. The debris basket may have a frame with a threaded central region and the valve housing has a central post with a threaded end configured to attach to the threaded central region of the debris basket. One or more raised struts may extend between the valve housing and a central post, wherein an upper surface of the central post is configured to receive an inset providing decorative branding.

A drain valve assembly comprises a valve housing, a plurality of slits formed through an upper region of the valve housing, and a plurality of anti-descent clips each having a bent end received within a corresponding slit, wherein the anti-descent clips are configured to anchor the valve housing against downward movement within a drain. The bent end of each clip may be a 90-degree elbow. The anti-descent clips are insertable without tools.

A drain screen and valve combination comprises a perforated drain screen having a central aperture, a removable insert received within the central aperture, the insert having an upper display surface for a logo or identifier and a threaded sleeve extending from an underside of the insert, a flapper post threadably engageable with the threaded sleeve and extending downward beneath the drain screen, and a flapper valve supported by the flapper post, wherein the insert simultaneously provides decorative branding and structural support for the flapper post. The drain screen and valve combination may further comprise a valve housing and a debris basket configured for attachment to a lower region of the valve housing. The debris basket may have bayonets extending from a frame which are received in bayonet slots in the lower region of the valve housing. The debris basket may have a frame with a threaded central region and the flapper post has a threaded end configured to attach to the threaded central region of the debris basket. The flapper valve includes one or more underside recess channels configured to assist collapse under pressure.

A drain screen and valve combination comprise a drain screen, a valve housing, wherein the drain screen and the valve housing are a single cast piece of metal, a single-use vent in the drain screen, the single-use vent assessable after installation, and a flapper valve in the valve housing and supported by a flapper post extending into the valve housing from a center of the drain screen. The combination may further comprise a medallion in the center of the drain screen and visible after installation, the medallion providing decorative branding.

A drain screen and valve combination comprise a drain screen, a plastic valve housing attached to the drain screen, a single-use vent in the drain screen, the single-use vent assessable after installation, and a flapper valve in the valve housing and supported by a flapper post extending into the valve housing from a center of the drain screen.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. A drain valve assembly, comprising:
a valve housing defining a flow passage;
a gasket on an exterior wall of the valve housing and comprising lower circumferential sealing veins and an upper circumferential sealing vein that has a diameter greater than a diameter of each of the lower circumferential sealing veins;
a flapper post positioned centrally within the valve housing;
a flapper valve attached to the flapper post; a debris basket attachment interface;
a removable debris basket; and
anti-descent clips disposed at an upper region of the valve housing and configured to resist downward movement of the valve housing.

2. The drain valve assembly of claim 1, wherein the upper sealing vein is at least 3 mm larger than the lower sealing veins.

3. The drain valve assembly of claim 1, wherein the debris basket interface is a bayonet coupling.

4. The drain valve assembly of claim 1, wherein the debris basket interface comprises a threaded bottom of the flapper post.

5. The drain valve assembly of claim 1, wherein the anti-descent clips are insertable before or after installation of a drain valve.

6. The drain valve assembly of claim 1, wherein the flapper valve includes one or more underside recess channels configured to assist collapse under pressure.

7. The drain valve assembly of claim 1, wherein the flapper valve is molded at an angle of between 53° and 63°, the angle measured from an underside of the flapper valve to the flapper post.

8. The drain valve assembly of claim 1, wherein the flapper post has a threaded upper end with an O-ring on the flapper post above the flapper valve and below the threaded upper end, the flapper post adjustable by rotating the threaded upper end in a threaded sleeve, the O-ring compressing between the flapper post and the threaded sleeve.

9. A drain valve assembly, comprising:
a valve housing having a plurality of outward ribs;
a gasket mounted over the outward ribs, the gasket comprising:
a plurality of lower circumferential sealing veins extending away from the valve housing; and
an upper circumferential sealing vein having a diameter greater than a diameter of each of the lower circumferential sealing veins; and
a debris basket configured for attachment to a lower region of the valve housing.

10. The drain valve assembly of claim 9, wherein the debris basket has bayonets extending from a frame which are received in bayonet slots in the lower region of the valve housing.

11. The drain valve assembly of claim 9, wherein the debris basket has a frame with a threaded central region and the valve housing has a central post with a threaded end configured to attach to the threaded central region of the debris basket.

12. The drain valve assembly of claim 9, further comprising one or more raised struts extending between the valve housing and a central post, wherein an upper surface of the central post is configured to receive an insert providing decorative branding.

13. A drain valve assembly, comprising:
a valve housing;
a plurality of slits formed through an upper region of the valve housing; and
a plurality of anti-descent clips each having a bent end received within a corresponding slit, wherein the anti-descent clips are configured to anchor the valve housing against downward movement within a drain.

14. The drain valve assembly of claim 13, wherein the bent end of each clip is a 90-degree elbow.

15. The drain valve assembly of claim 13, wherein the anti-descent clips are insertable without tools.

16. A drain screen and valve combination, comprising:
a perforated drain screen having a central aperture;
a removable insert received within the central aperture, the insert comprising:
an upper display surface for a logo or identifier, and
a threaded sleeve extending from an underside of the insert;
a flapper post threadably engageable with the threaded sleeve and extending downward beneath the drain screen; and
a flapper valve supported by the flapper post, wherein the insert simultaneously provides decorative branding and structural support for the flapper post.

17. The drain screen and valve combination of claim 16, further comprising a valve housing and a debris basket configured for attachment to a lower region of the valve housing.

18. A drain screen and valve combination, comprising:
a drain screen;
a valve housing, wherein the drain screen and the valve housing are a single cast piece of metal;
a single-use vent in the drain screen, the single-use vent assessable after installation; and
a flapper valve in the valve housing and supported by a flapper post extending into the valve housing from a center of the drain screen.

19. The drain screen and valve combination of claim 18, further comprising:
a medallion in the center of the drain screen and visible after installation, the medallion providing decorative branding.

20. A drain screen and valve combination, comprising:
a drain screen;
a plastic valve housing attached to the drain screen;
a single-use vent in the drain screen, the single-use vent assessable after installation; and
a flapper valve in the valve housing and supported by a flapper post extending into the valve housing from a center of the drain screen.
